(19) United States
(12) Patent Application Publication
(10) Pub. No.: US 2026/0343118 A1
(43) Pub. Date: Oct. 29, 2026

(54) SOLID-STATE IMAGING DEVICE

(71) Applicant: HAMAMATSU PHOTONICS K.K., Hamamatsu-shi, Shizuoka (JP)

(72) Inventors: Munenori TAKUMI, Hamamatsu-shi, Shizuoka (JP); Keisuke UCHIDA, Hamamatsu-shi, Shizuoka (JP)

(73) Assignee: HAMAMATSU PHOTONICS K.K., Hamamatsu-shi, Shizuoka (JP)

(21) Appl. No.: 19/471,414

(22) PCT Filed: Feb. 15, 2024
(86) PCT No.: PCT/JP2024/005286

§ 371 Date: Oct. 1, 2025

(30) Foreign Application Priority Data
Apr. 3, 2023 (JP) 2023-060225

(51) Int. Cl. H04N 25/707; H04N 25/47

(52) U.S. Cl. CPC H04N 25/707; H04N 25/47

(57) ABSTRACT

A solid-state imaging device includes a light receiving unit, a readout unit, a selection unit, a counter group, a processing unit, and a control unit. The light receiving unit includes N pixels. The counter group includes M counters. Each of the pixels detects an event, and outputs an event signal. The selection unit selects, based on a correspondence relationship among each pixel, each event type, and the counter, a plurality of counters corresponding to the pixel outputting the event signal and the event type, and inputs the event signal to the selected plurality of counters.

### TECHNICAL FIELD

The present disclosure relates to a solid-state imaging device.

### BACKGROUND ART

A solid-state imaging device, in general, includes a light receiving unit in which a plurality of pixels are arranged, each for outputting a signal in response to light incidence, and based on the output signal from each of the plurality of pixels, it is possible to acquire an image of the light incident on the light receiving unit.

An imaging technique performed by using compressive sensing is also known (Patent Document 1, Non Patent Document 1). In the above imaging technique, for each of a plurality of mask patterns (compression patterns), several pixels are selected out of the plurality of pixels in the light receiving unit according to the mask pattern, and a sum of the signals output respectively from the selected several pixels is obtained. Further, by performing required processing based on the sum of the signals obtained for each of the plurality of mask patterns, it is possible to reconstruct the image of the light incident on the light receiving unit.

The above technique requires sequential switching of the plurality of mask patterns to obtain the sum of the output signals, and thus, a time required to acquire data necessary for the image reconstruction is long, and in the case in which a change in the image of the light is fast, motion blur may occur. In order to avoid the above situation, it is necessary to increase a frame rate, and in that case, power consumption increases.

A solid-state imaging device of an event driven type is also known (Patent Documents 2 and 3, Non Patent Document 2). In the above solid-state imaging device, each of the plurality of pixels arranged in the light receiving unit, when an event (for example, a change in an incident light intensity) is detected, outputs an event signal indicating the detection of the event. Each of the plurality of pixels does not output the event signal when the event is not detected.

In the above solid-state imaging device, only the pixel in which the event is detected out of the plurality of pixels arranged in the light receiving unit asynchronously outputs a position signal indicating a position of the pixel and the event signal to a processing unit of a subsequent stage. Further, the processing unit, which receives the position signal and the event signal from the pixel, can obtain the change in the image of the light incident on the light receiving unit. The above solid-state imaging device is expected to reduce the power consumption depending on an imaging target.

### CITATION LIST

### Patent Literature

Patent Document 1: Japanese Patent Application Laid-Open Publication No. 2022-112364
Patent Document 2: Japanese Patent Application Laid-Open Publication No. 2022-548199
Patent Document 3: Japanese Patent Application Laid-Open Publication No. 2021-524705

### Non Patent Literature

Non Patent Document 1: L. Jacques et al., “CMOS compressed imaging by Random Convolution”, Proceedings: 2009 IEEE International Conference on Acoustics, Speech and Signal Processing (2009)
Non Patent Document 2: Thomas Finateu et al., “A 1280×720 Back-Illuminated Stacked Temporal Contrast Event-Based Vision Sensor with 4.86 μm Pixels, 1.066GEPS Readout, Programmable Event-Rate Controller and Compressive Data-Formatting Pipeline”, ISSCC 2020/SESSION 5/IMAGERS AND ToF SENSORS/5.10 (2020)

### SUMMARY OF INVENTION

### Technical Problem

In the conventional solid-state imaging device of the event driven type, when each of the plurality of pixels detects the event, the position signal and the event signal is transmitted to the processing unit of the subsequent stage, and thus, a bandwidth required for transmission of the signals is large.

An object of an embodiment is to provide a solid-state imaging device of an event driven type capable of reducing both power consumption and signal transmission bandwidth.

### Solution to Problem

An embodiment is a solid-state imaging device. The solid-state imaging device includes (1) a light receiving unit in which N pixels are arranged, the N pixels each for detecting K types of events based on incidence of light, and outputting an event signal indicating an event detection; (2) a counter group including M counters, each for counting an event detection number based on input of the event signal (in which 1<M<NK); and (3) a selection unit for selecting, based on a correspondence relationship among each pixel out of the N pixels, each event type out of the K types of events, and a plurality of counters out of the M counters, the plurality of counters corresponding to the pixel outputting the event signal and the event type, and inputting the event signal to the selected plurality of counters.

### Advantageous Effects of Invention

According to the solid-state imaging device of the embodiment, it is possible to provide a solid-state imaging device of an event driven type capable of reducing both power consumption and signal transmission bandwidth.

### BRIEF DESCRIPTION OF DRAWINGS

FIG. 1 is a diagram illustrating a configuration of a solid-state imaging device 1A according to a first embodiment.

FIG. 2 is a diagram illustrating a configuration of each pixel 12A of the solid-state imaging device 1A according to the first embodiment.

FIG. 3 is a diagram for describing a frame and a subframe.

FIG. 4 is a diagram illustrating a configuration of a solid-state imaging device 1B according to a second embodiment.

FIG. 5 is a diagram illustrating a configuration of each area 11B of the solid-state imaging device 1B according to the second embodiment.

FIG. 6 is a diagram illustrating a configuration of each pixel 12B of the solid-state imaging device 1B according to the second embodiment.

FIG. 7 is a diagram illustrating a configuration of each pixel 12C of a solid-state imaging device according to a third embodiment.

### DESCRIPTION OF EMBODIMENTS

Hereinafter, embodiments of a solid-state imaging device will be described in detail with reference to the accompanying drawings. In the description of the drawings, the same elements will be denoted by the same reference signs, and redundant description will be omitted. The present invention is not limited to these examples, and the Claims, their equivalents, and all the changes within the scope are intended as would fall within the scope of the present invention.

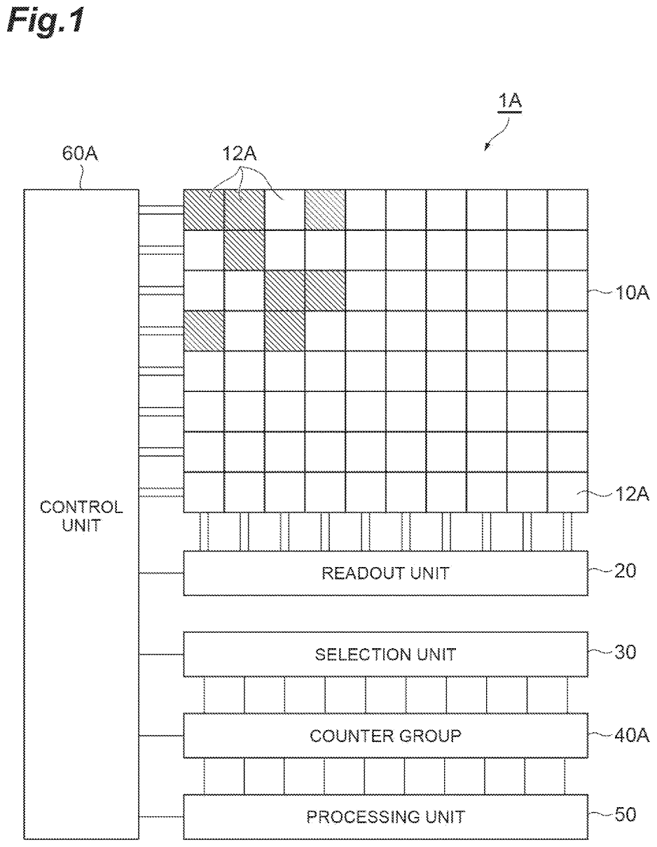

FIG. 1 is a diagram illustrating a configuration of a solid-state imaging device 1A according to a first embodiment. The solid-state imaging device 1A includes a light receiving unit 10A, a readout unit 20, a selection unit 30, a counter group 40A, a processing unit 50, and a control unit 60A. The light receiving unit 10A includes N pixels 12A which are arranged two-dimensionally (in the diagram, 8 rows and 10 columns). Further, the N pixels 12A may be arranged one-dimensionally. The counter group 40A includes M counters. The light receiving unit 10A, the readout unit 20, the selection unit 30, the counter group 40A, and the processing unit 50 respectively operate under the control of the control unit 60A.

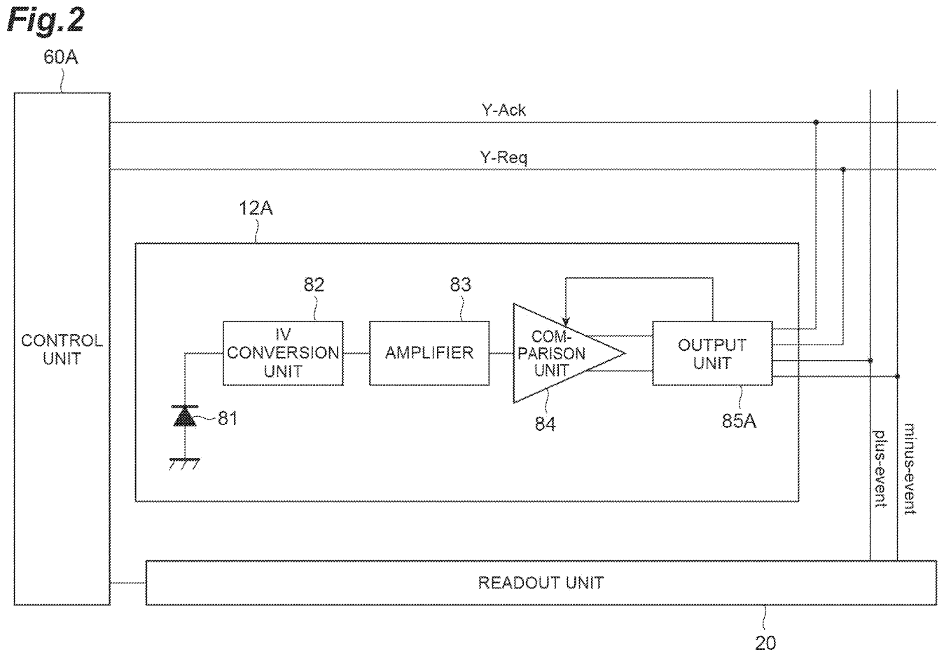

FIG. 2 is a diagram illustrating a configuration of each of the pixels 12A of the solid-state imaging device 1A according to the first embodiment. This diagram is a diagram for describing a relationship between each of the pixels 12A and the readout unit 20 and the control unit 60A, in addition to the description of the configuration of each of the pixels 12A.

The N pixels 12A have a common configuration. The pixel 12A includes a photodiode 81, an IV conversion unit 82, an amplifier 83, a comparison unit 84, and an output unit 85A. The photodiode 81 generates charges in response to incidence of light, and outputs a current signal to the IV conversion unit 82. A magnitude of the current signal output from the photodiode 81 (a charge generation amount per unit time) is a magnitude according to an intensity of the light incident on the photodiode 81.

The IV conversion unit 82 inputs the current signal output from the photodiode 81, and outputs a voltage signal having a value according to the input current value to the amplifier 83. The amplifier 83 inputs the voltage signal output from the IV conversion unit 82, amplifies the input voltage signal, and outputs the voltage signal after the amplification to the comparison unit 84.

The comparison unit 84 inputs the voltage signal output from the amplifier 83, and compares magnitudes of the input voltage value Vᵢₙ and a reference voltage value V_{ref}. In the case in which the input voltage value Vᵢₙ is larger than a value obtained by adding a first threshold value Vₜₕ₁ to the reference voltage value V_{ref}(V_{ref}+Vₜₕ₁<Vᵢₙ), the comparison unit 84 determines that a plus event occurs. In the case in which the input voltage value Vᵢₙ is smaller than a value obtained by subtracting a second threshold value Vₜₕ₂ from the reference voltage value V_{ref}(Vᵢₙ<V_{ref}−Vₜₕ₂), the comparison unit 84 determines that a minus event occurs. When the comparison unit 84 determines that any one of the two types of events (the plus event and the minus event) occurs, an event signal indicating the occurrence of the event is output to the output unit 85A.

The reference voltage value V_{ref} in the comparison unit 84 is reset at the time of power on of the solid-state imaging device 1A by an instruction from the control unit 60A, and is updated for each frame period set in advance. Further, the reference voltage value V_{ref} in the comparison unit 84 is updated when the event signal is output to the output unit 85A. By the above update, the input voltage value Vᵢₙ at that time is set as the new reference voltage value V_{ref}.

When the event signal is received from the comparison unit 84, the output unit 85A sets a Y-Req line connected to the pixel to High, and notifies the control unit 60A of an event signal output request. When a notification of an event signal output acknowledgment is received from the control unit 60A via a Y-Ack line, the output unit 85A outputs the event signal to the readout unit 20 via a plus event line or a minus event line, and sets the Y-Req line to High-Z. By using the above configuration, even in the case in which the event signal output requests are output simultaneously from a plurality of pixels, adjustment of the event signal output acknowledgment can be performed, and thus, the event signal can be read out while avoiding collision of the event signal output.

One Y-Req line and one Y-Ack line are provided for each row of the plurality of pixels 12A out of the N pixels 12A arranged two-dimensionally in the light receiving unit 10A. One plus event line and one minus event line are provided for each column of the plurality of pixels 12A out of the N pixels 12A arranged two-dimensionally in the light receiving unit 10A.

Returning to FIG. 1, the explanation will be continued. The readout unit 20 receives the output signals from the pixels 12A in the row receiving the notification of the event signal output acknowledgment from the control unit 60A, out of the N pixels 12A arranged two-dimensionally in the light receiving unit 10A, via the plus event line or the minus event line. Further, the readout unit 20 identifies the pixel 12A outputting the event signal out of the pixels, and outputs the position information in the X direction of the pixel and the event signal to the control unit 60A.

The control unit 60A, based on the position information in the X direction of the pixel and the event signal received from the readout unit 20, and the position information in the Y direction of the pixel received from the light receiving unit 10A via the Y-Req line, can obtain the XY position information (a pixel address) of the pixel detecting the event, and further, can obtain the type of the event detected in the pixel (whether it is the plus event or the minus event).

The selection unit 30, based on a correspondence relationship among each pixel out of the N pixels 12A in the light receiving unit 10A and each event information, and a plurality of counters out of the M counters in the counter group 40A, selects the plurality of counters corresponding to the pixel outputting the event signal and the event type, and inputs the event signal to the selected plurality of counters. The selection unit 30 may be configured to include a decoding circuit provided for selecting the corresponding plurality of counters based on the XY position information (the pixel address) of each pixel and the event type.

In the present embodiment, the two event types of the plus event and the minus event are provided as the event type, and thus, the selection unit 30 selects the corresponding plurality of counters based on the XY position information (the pixel address) of each pixel and the event type (whether it is the plus event or the minus event). In other words, each counter included in the counter group 40A inputs the event signal of the corresponding event type from the corresponding pixel. In FIG. 1, as an example, the pixels corresponding to a certain one counter included in the counter group 40A are indicated by hatching.

The correspondence relationship among the pixel, the event type, and the counter may be determined in advance as an optimal combination, and further, may be determined by using a Hadamard matrix or the like. Each counter may be provided corresponding to the pixels in a specific area of the light receiving unit 10A. In addition, each event type of each pixel needs to correspond to a plurality of counters.

Each counter in the counter group 40A counts the event detection number based on the event signal from the corresponding pixel. Each counter in the counter group 40A outputs the count value to the processing unit 50 at the end of each frame period, and then resets the count value.

The processing unit 50 reconstructs a change in the image of the light incident on the light receiving unit 10A by using a compressive sensing technique, based on the correspondence relationship among the pixel, the event type, and the counter in the selection unit 30 and the count value of each counter in the counter group 40A. In this case, the processing unit 50 may be configured by using, for example, a digital circuit or the like in which an image reconstruction algorithm by using the compressive sensing is implemented.

In addition, the processing unit 50 may be configured to perform inference by using a machine learning unit, based on the correspondence relationship among the pixel, the event type, and the counter in the selection unit 30 and the count value of each counter in the counter group 40A. By the above inference, it may be possible to reconstruct or evaluate the change in the image of the light incident on the light receiving unit 10A, and further, it may be possible to determine the state of the imaging target (for example, the occurrence of a fallen person in the image or the like) from the evaluation result. The machine learning unit may be configured to include an AI chip in which an inference model such as a neural network or a reservoir computing is implemented.

In the case in which the processing unit 50 reconstructs the change in the image of the light incident on the light receiving unit 10A by using the compressive sensing technique, the processing unit 50 performs the following processing.

When the measurement data (the M counter values) is represented by a vector y, the image to be reconstructed is represented by a vector x, and a sensing matrix is set to Φ, the relationship among these is represented by the following Formula (1). An element yₘ of the measurement data vector y (the following Formula (2)) is the count value yₘ of the m-th counter out of the M counters. An element x_{n,k} of the image vector x (the following Formula (3)) represents the number of occurrences of the k-th type event out of the K types of events in the n-th pixel, in which the position of each of the N pixels arranged two-dimensionally is represented by a one-dimensional variable n. In the present embodiment, it is set to K=2.

[Formula 1]

y=φx (1)

[Formula 2]

y=(y₁,y₁, . . . ,y_{M}) (2)

[Formula 3]

x=(x_{1,1},x_{1,2}, . . . ,x_{1,K},x_{2,1}, . . . ,x_{N,K}) (3)

An element φ_{m,n,k} of the sensing matrix Φ (the following Formula (4)) takes different values depending on whether the m-th counter, the n-th pixel, and the k-th type event have the correspondence relationship in the selection unit 30. For example, in the case in which the m-th counter, the n-th pixel, and the k-th type event have the correspondence relationship, it is set to φ_{m,n,k}≠0. On the other hand, in the case in which the m-th counter, the n-th pixel, and the k-th type event do not have the correspondence relationship, it is set to φ_{m,n,k}=0.

$$\begin{matrix}[ Formula 4 ] & \\ & ( 4 )\end{matrix}$$

$$Φ = ( \begin{matrix}{ϕ}_{1 , 1 , 1} & {ϕ}_{1 , 1 , 2} & … & {ϕ}_{1 , 1 , K} & {ϕ}_{1 , 2 , 1} & … & {ϕ}_{1 , N , K} \\ {ϕ}_{2 , 1 , 1} & {ϕ}_{2 , 1 , 2} & … & {ϕ}_{2 , 1 , K} & {ϕ}_{2 , 2 , 1} & … & {ϕ}_{2 , N , K} \\ ⋮ & ⋮ & ⋱ & ⋮ & ⋮ & ⋱ & ⋮ \\ {ϕ}_{M , 1 , 1} & {ϕ}_{M , 1 , 2} & … & {ϕ}_{M , 1 , K} & {ϕ}_{M , 2 , 1} & … & {ϕ}_{M , N , K}\end{matrix} )$$

With respect to the number of elements NK of the image vector x to be reconstructed, the number of elements M of the measurement data vector y is small, and there is a relationship of 1<M<NK. The reconstruction of the image vector x is an underdetermined problem. Therefore, the formula to be actually solved becomes an optimization problem represented by the following Formula (5) or Formula (6).

$$\begin{matrix}[ Formula 5 ] & \\ {min}_{x ϵ {R}^{NK}} \frac{1}{2} {‖ {Φ}_{x - y} ‖}_{2}^{2} + λ {‖ x ‖}_{0} & ( 5 )\end{matrix}$$

$$\begin{matrix}[ Formula 6 ] & \\ {min}_{x ϵ {R}^{NK}} \frac{1}{2} {‖ {Φ}_{x - y} ‖}_{2}^{2} + λ {‖ x ‖}_{1} & ( 6 )\end{matrix}$$

By solving the above optimization problem, the image vector x can be reconstructed. In the case of the imaging target in which the events occur only in a small number of pixels, sparsity is considered to exist, and thus, the optimization problem can be solved. In addition, for example, the matrix to be obtained may be transformed by total variation or the like to make it sparse.

For example, when the number of pixels N is set to 1024×1024=1,048,576, the number of event types K is set to 2, and the number of counters having the correspondence relationship with respect to each pixel and each event type is set to 16, the total number of counters M can be set to 262,144. In the conventional solid-state imaging device of the event driven type, it is necessary to transmit information on the K event types for each of the N pixels to the processing unit.

On the other hand, in the solid-state imaging device of the present embodiment, it is sufficient to transmit information on the count values of the M (=262,144) counters to the processing unit, and thus, the signal transmission bandwidth can be reduced as compared with the conventional device. Further, the solid-state imaging device of the present embodiment is of the event driven type, and thus, the power consumption can be reduced. Further, in the case in which the imaging target is sparser, the number of counters M may be even smaller.

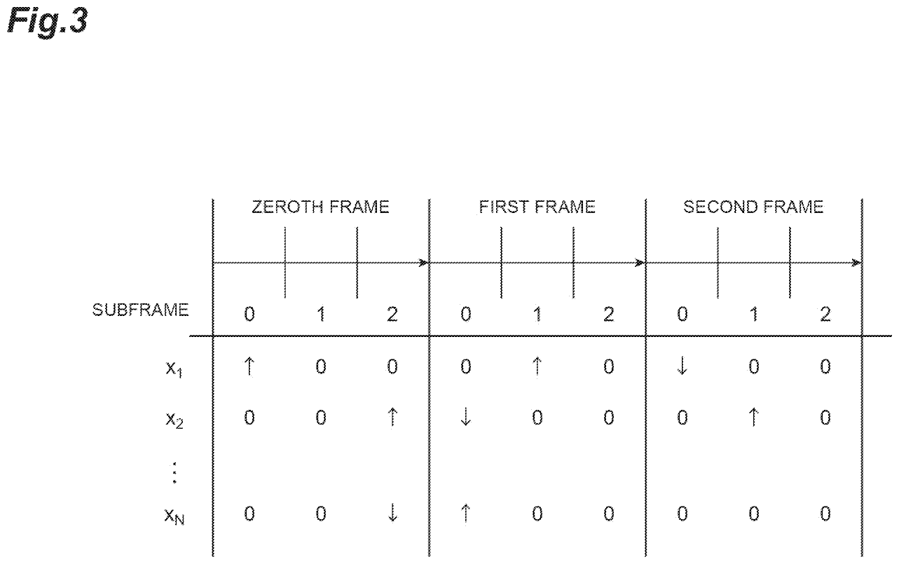

It is also possible to further add other event information. For example, the control unit 60A may set a predetermined fixed period into one frame, and in addition, may divide it into smaller subframes by a timer. FIG. 3 is a diagram for describing the frame and the subframe. In this diagram, the plus event is indicated by an upward arrow, and the minus event is indicated by a downward arrow.

As shown in this diagram, in the case in which each frame is divided into three subframes, there are the two types of events (the plus event and the minus event) for each of the three subframes, and thus, the number of event types K for each frame becomes 6. The image vector x to be reconstructed becomes a vector including subframe information of each pixel, and the temporal resolution is improved.

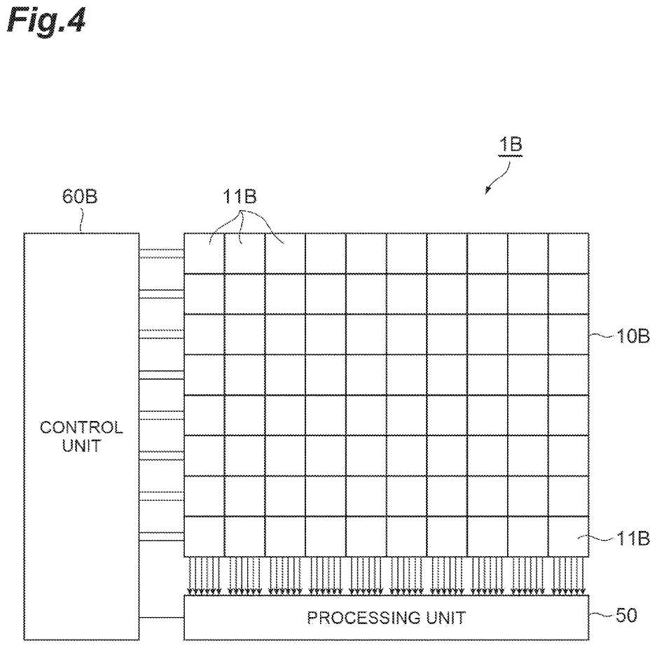

Next, a solid-state imaging device 1B of a second embodiment will be described with reference to FIG. 4 to FIG. 6. Differences from the configuration of the solid-state imaging device 1A according to the first embodiment will be mainly described.

FIG. 4 is a diagram illustrating a configuration of a solid-state imaging device 1B according to a second embodiment. The solid-state imaging device 1B includes a light receiving unit 10B, the processing unit 50, and a control unit 60B. The light receiving unit 10B is divided into a plurality of areas 11B arranged two-dimensionally (in the diagram, 8 rows and 10 columns). Further, the plurality of areas 11B may be arranged one-dimensionally. The light receiving unit 10B and the processing unit 50 respectively operate under the control of the control unit 60B.

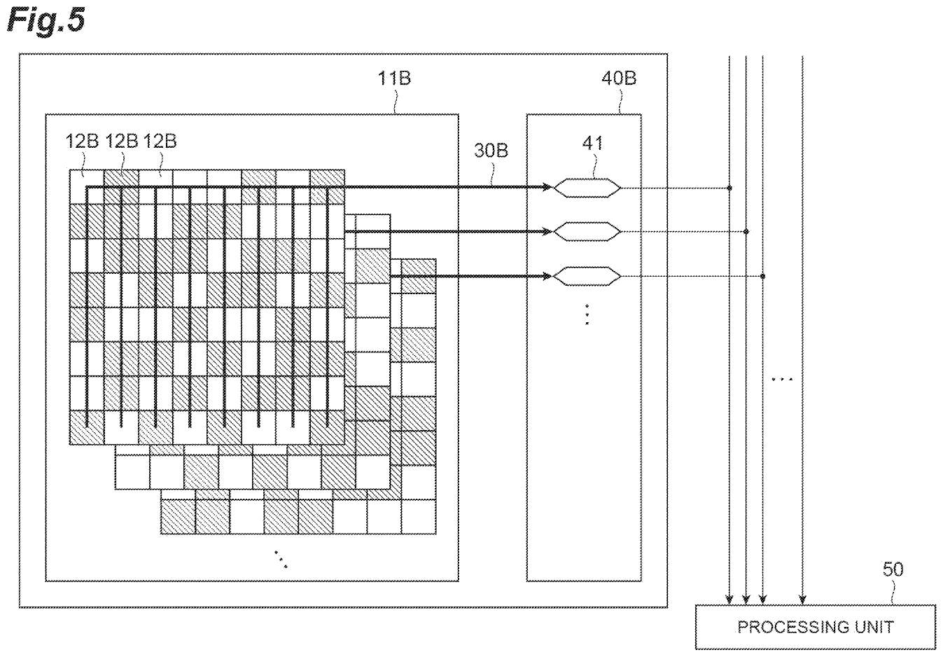

FIG. 5 is a diagram illustrating a configuration of each of the areas 11B of the solid-state imaging device 1B according to the second embodiment. The area 11B includes a plurality of pixels 12B arranged two-dimensionally (in the diagram, 8 rows and 8 columns). Further, the plurality of pixels 12B may be arranged one-dimensionally. For each area 11B, a counter group 40B including a plurality of counters 41 is provided.

In this embodiment, the selection unit includes a fixed wiring line 30B for electrically connecting each pixel and a plurality of counters corresponding to the pixel. In this diagram, the pixels connected to each counter 41 included in the counter group 40B by the fixed wiring line are indicated by hatching.

The correspondence relationship among the pixel, the event type, and the counter by the fixed wiring line 30B may be determined in advance as an optimal combination, and further, may be determined by using a Hadamard matrix or the like. The number of fixed wiring lines 30B is equal to the number of counters 41. Further, in order to avoid the collision of the event signal output among the pixels 12B, for example, a function for prioritizing adjacent upper, left, and left-upper pixels, and the like may be added in each area 11B.

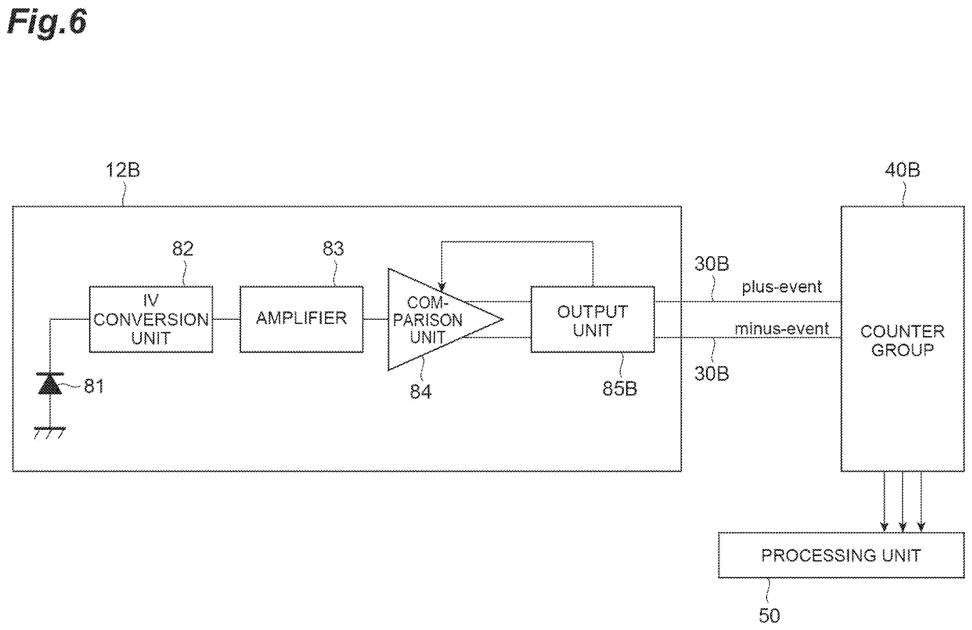

FIG. 6 is a diagram illustrating a configuration of each of the pixels 12B of the solid-state imaging device 1B according to the second embodiment. The pixel 12B includes the photodiode 81, the IV conversion unit 82, the amplifier 83, the comparison unit 84, and an output unit 85B. As compared with the configuration of the pixel 12A of the first embodiment illustrated in FIG. 2, the pixel 12B of the second embodiment illustrated in FIG. 6 is different in that the pixel includes the output unit 85B instead of the output unit 85A.

The output unit 85B does not need to send the event signal output request to the control unit 60B via the Y-Req line, and further, does not need to receive the notification of the event signal output acknowledgment via the Y-Ack line. The counter value of each area 11B is reset at the time of power on, and the counter values of all the areas are sequentially read out for each frame by using a rolling shutter configuration or by using a global shutter configuration, and then the reset is performed again.

In the case in which the processing unit 50 reconstructs the change in the image of the light incident on the light receiving unit 10B by using the compressive sensing technique, it is sufficient to solve the optimization problem by the above Formula (1) to Formula (6), for the entire light receiving unit 10B, for each of the plurality of areas 11B, or for any combination of the plurality of areas 11B. For example, the number N of pixels 12B included in each area 11B may be set to 8×8=64, the event type number K may be set to 2, and the number of counters having the correspondence relationship with respect to each pixel and each event type in each area 11B may be set to 16. Further, the number of areas 11B may be set to 128×128.

In the solid-state imaging device of the present embodiment also, it is sufficient to transmit information on the 262,144 count values to the processing unit, and thus, the signal transmission bandwidth can be reduced as compared with the conventional device. Further, the solid-state imaging device of the present embodiment is of the event driven type, and thus, the power consumption can be reduced. Further, in the case in which the imaging target is sparser, the number of counters M may be even smaller.

Next, a solid-state imaging device of a third embodiment will be described. Differences from the configuration of the solid-state imaging device 1B according to the second embodiment will be mainly described.

In the solid-state imaging device 1A of the first embodiment and the solid-state imaging device 1B of the second embodiment described above, each pixel detects the increase or decrease of the incident light intensity as the event. On the other hand, in the solid-state imaging device according to the third embodiment, each pixel detects an increase of an amount of photo charges accumulated in a capacitor included in the pixel as the event. As compared with the configuration of the solid-state imaging device 1B of the second embodiment, the solid-state imaging device of the third embodiment is different in the configuration of each pixel.

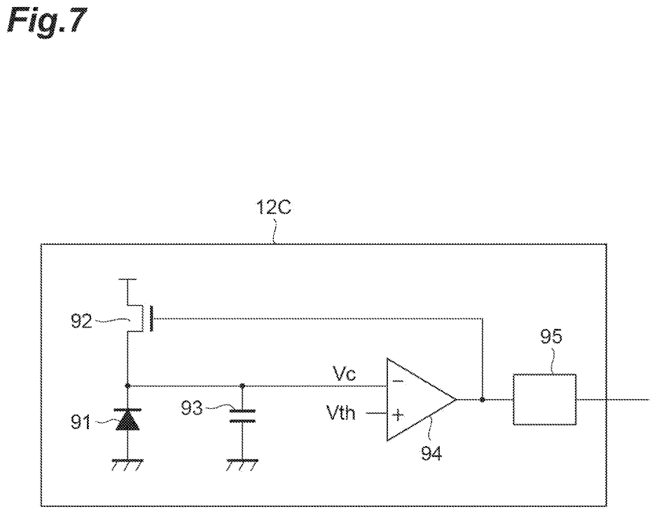

FIG. 7 is a diagram illustrating a configuration of each of pixels 12C of the solid-state imaging device according to the third embodiment. The pixel 12C includes a photodiode 91, a transistor 92, a capacitor 93, a comparison unit 94, and an output unit 95. An anode of the photodiode 91 is connected to a ground potential supply terminal. A cathode of the photodiode 91 is connected to a power potential supply terminal via the transistor 92, connected to the ground potential supply terminal via the capacitor 93, and further, connected to one input terminal out of two input terminals of the comparison unit 94.

The comparison unit 94 inputs a potential Vc of the capacitor 93 (the potential of the cathode of the photodiode 91) at the one input terminal, and inputs a threshold potential Vth at the other input terminal, and compares magnitudes of the above two potentials Vc and Vth. In the case in which the potential Vc is higher than the threshold potential Vth, the comparison unit 94 sets a potential of an output terminal to L level, and in the case in which the potential Vc is equal to or lower than the threshold potential Vth, the comparison unit 94 sets the potential of the output terminal to H level. The output terminal of the comparison unit 94 is connected to the output unit 95, and further, connected to a gate of the transistor 92.

In the pixel 12C having the configuration described above, an accumulated charge amount in the capacitor 93 is reset at the time of power on, by an instruction from the control unit, and further, is updated for each frame period set in advance. The negative charges generated in the photodiode 91 in response to the incidence of the light are accumulated in the capacitor 93.

By the accumulation of the negative charges described above, the potential Vc gradually decreases, and eventually the potential Vc becomes lower than the threshold potential Vth. When the potential Vc becomes lower than the threshold potential Vth, the output terminal of the comparison unit 94 changes from the L level to the H level, and as a result, the transistor 92 is set to the ON state. When the transistor 92 is set to the ON state, the accumulated charge amount in the capacitor 93 is reset, and the output terminal of the comparison unit 94 returns from the H level to the L level.

That is, each time a certain amount of charges is generated in the photodiode 91, a pulse is output from the output terminal of the comparison unit 94. A pulse generation frequency corresponds to the incident light intensity. The above pulse is output to the counter via the output unit 95 as the event signal indicating the increase of the amount of the photo charges accumulated in the capacitor 93. In the present embodiment, the event type number K is set to 1.

In the case in which the processing unit reconstructs the image of the light incident on the light receiving unit by using the compressive sensing technique, it is sufficient to solve the optimization problem by the above Formula (1) to Formula (6), for the entire light receiving unit, for each of the plurality of areas, or for any combination of the plurality of areas. For example, the number N of pixels 12C included in each area may be set to 8×8=64, the event type number K may be set to 1, and the number of counters having the correspondence relationship with respect to each pixel in each area may be set to 8. Further, the number of areas may be set to 128×128.

In the solid-state imaging device of the present embodiment, it is sufficient to transmit information on 131,072 count values to the processing unit, and thus, the signal transmission bandwidth can be reduced as compared with the conventional device. Further, the solid-state imaging device of the present embodiment is of the event driven type, and thus, the power consumption can be reduced. Further, in the case in which the imaging target is sparser, the number of counters M may be even smaller.

The solid-state imaging device is not limited to the embodiments and configuration examples described above, and various modifications are possible. For example, the event detected by each pixel may be set to an arbitrary event. Each pixel may detect the event related to the intensity of the light incident on the pixel, and further, may detect the event related to a polarization state or a wavelength of the light. Each pixel may detect the event related to the accumulated charge amount in the pixel, and further, may detect the event related to a current signal or a voltage signal in the pixel.

The processing unit does not necessarily have to be included in the solid-state imaging device, and may be a hardware device including a central processing unit (CPU), a graphics processing unit (GPU), a field-programmable gate array (FPGA), an application specific integrated circuit (ASIC), a system on a chip (SoC), or the like, which is connected to the solid-state imaging device. Further, the processing unit may be a cloud device connected to the solid-state imaging device via a network.

The solid-state imaging device of a first aspect according to the above embodiment includes (1) a light receiving unit in which N pixels are arranged, the N pixels each for detecting K types of events based on incidence of light, and outputting an event signal indicating an event detection; (2) a counter group including M counters, each for counting an event detection number based on input of the event signal (in which 1<M<NK); and (3) a selection unit for selecting, based on a correspondence relationship among each pixel out of the N pixels, each event type out of the K types of events, and a plurality of counters out of the M counters, the plurality of counters corresponding to the pixel outputting the event signal and the event type, and inputting the event signal to the selected plurality of counters.

In the solid-state imaging device of a second aspect, in the configuration of the first aspect, the selection unit may include a circuit for selecting the plurality of counters corresponding to each pixel based on position information of the pixel.

In the solid-state imaging device of a third aspect, in the configuration of the first aspect, the selection unit may include a fixed wiring line for electrically connecting each pixel and the plurality of counters corresponding to the pixel.

In the solid-state imaging device of a fourth aspect, in the configuration of any one of the first to third aspects, the light receiving unit may be divided into a plurality of areas, and the counter group may be provided for each of the plurality of areas.

In the solid-state imaging device of a fifth aspect, in the configuration of any one of the first to fourth aspects, each of the N pixels may detect the event related to the light incident on the pixel.

In the solid-state imaging device of a sixth aspect, in the configuration of any one of the first to fifth aspects, each of the N pixels may detect the event related to an electrical signal in the pixel.

In the solid-state imaging device of a seventh aspect, in the configuration of any one of the first to sixth aspects, the device may further include a processing unit for reconstructing an image of the light incident on the light receiving unit or a change in the image by using a compressive sensing technique, based on the correspondence relationship between the pixel and the counter in the selection unit and a count value of each of the M counters.

In the solid-state imaging device of an eighth aspect, in the configuration of any one of the first to sixth aspects, the device may further include a processing unit for performing inference by using a machine learning unit, based on the correspondence relationship between the pixel and the counter in the selection unit and a count value of each of the M counters.

### INDUSTRIAL APPLICABILITY

The embodiments can be used as a solid-state imaging device of an event driven type capable of reducing both power consumption and signal transmission bandwidth.

### REFERENCE SIGNS LIST

1A, 1B—solid-state imaging device, 10A, 10B—light receiving unit, 11B—area, 12A-12C—pixel, 20—readout unit, 30—selection unit, 40A, 40B—counter group, 41—counter, 50—processing unit, 60A, 60B—control unit, 81—photodiode, 82—IV conversion unit, 83—amplifier, 84—comparison unit, 85A, 85B—output unit, 91—photodiode, 92—transistor, 93—capacitor, 94—comparison unit, 95—output unit, 30B—fixed wiring line.

1. A solid-state imaging device comprising:
a light receiving unit in which N pixels are arranged, the N pixels each configured to detect K types of events based on incidence of light, and output an event signal indicating an event detection;
a counter group including M counters, each configured to count an event detection number based on input of the event signal (in which 1<M<NK); and
a selection unit configured to select, based on a correspondence relationship among each pixel out of the N pixels, each event type out of the K types of events, and a plurality of counters out of the M counters, the plurality of counters corresponding to the pixel outputting the event signal and the event type, and input the event signal to the selected plurality of counters.

2. The solid-state imaging device according to claim 1, wherein the selection unit includes a circuit configured to select the plurality of counters corresponding to each pixel based on position information of the pixel.

3. The solid-state imaging device according to claim 1, wherein the selection unit includes a fixed wiring line configured to electrically connect each pixel and the plurality of counters corresponding to the pixel.

4. The solid-state imaging device according to claim 1, wherein the light receiving unit is divided into a plurality of areas, and the counter group is provided for each of the plurality of areas.

5. The solid-state imaging device according to claim 1, wherein each of the N pixels is configured to detect the event related to the light incident on the pixel.

6. The solid-state imaging device according to claim 1, wherein each of the N pixels is configured to detect the event related to an electrical signal in the pixel.

7. The solid-state imaging device according to claim 1, further comprising a processing unit configured to reconstruct an image of the light incident on the light receiving unit or a change in the image by using a compressive sensing technique, based on the correspondence relationship between the pixel and the counter in the selection unit and a count value of each of the M counters.

8. The solid-state imaging device according to claim 1, further comprising a processing unit configured to perform inference by using a machine learning unit, based on the correspondence relationship between the pixel and the counter in the selection unit and a count value of each of the M counters.
